(19) United States
(12) Patent Application Publication
(10) Pub. No.: US 2021/0097103 A1
(43) Pub. Date: Apr. 1, 2021

(54) METHOD AND SYSTEM FOR AUTOMATICALLY COLLECTING AND UPDATING INFORMATION ABOUT POINT OF INTEREST IN REAL SPACE

(71) Applicant: NAVER LABS CORPORATION, Seongnam-si (KR)

(72) Inventors: Sang Chul KANG, Seongnam-si (KR); Jeonghee KIM, Seongnam-si (KR)

(73) Assignee: NAVER LABS CORPORATION, Seongnam-si (KR)

(21) Appl. No.: 17/122,318

(22) Filed: Dec. 15, 2020

Related U.S. Application Data
(63) Continuation of application No. PCT/KR2019/006970, filed on Jun. 11, 2019.

(30) Foreign Application Priority Data
Jun. 15, 2018 (KR) 10-2018-0068652

(51) Int. Cl. G06F 16/587; G06F 16/29; G06K 9/00; G01C 21/34

(52) U.S. Cl. CPC G06F 16/587; G01C 21/3476; G06K 9/00684; G06F 16/29

(57) ABSTRACT

Provided are methods and systems for automatically collecting and updating information that is related to a point of interest in real space. According to the methods, information relating to a plurality of points of interest (POIs), which exist in real space, is automatically collected and compared to previously collected information, and if there is a change, the change can be automatically updated so as to provide a location-based service, such as a map service, in real space such as a downtown street or a mall.

### CROSS-REFERENCE TO RELATED APPLICATIONS

This U.S. non-provisional application is a continuation of and claims the benefit of priority under 35 U.S.C. § 365(c) to International Application PCT/KR2019/006970, which has an International filing date of Jun. 11, 2019 and claims priority to Korean Patent Application No. 10-2018-0068652, filed Jun. 15, 2018, the entire contents of each of which are incorporated herein by reference in their entirety.

### BACKGROUND

### Technical Field

The present disclosure relates to methods and/or systems for automatically collecting and updating information on a point of interest in a real space and, more particularly, to information collection and update methods capable of automatically collecting information on multiple points of interest (POIs) present in a real space for a location-based service, such as a map, in a real space environment, such as a city street or an indoor shopping mall, and automatically updating a change when there is the change as a result of a comparison with previously collected information, and/or information collection and update systems performing the information collection and update method.

### Related Art

Various forms of POIs, such as a restaurant, a bookstore, and a store, are present in a real space. In order to display information on such a POI (hereinafter referred to as “POI information”) in a map or to provide the information to a user, corresponding POI information needs to be collected. Conventionally, a method of directly visiting, by a person, a real space through walking or a vehicle, directly checking the location, category, name, etc. of a POI, and recording the location, category, name, etc. on a system or capturing images of a real space, a road, etc. using a camera through a vehicle on which the camera is installed, subsequently analyzing, by a person, the photographed images, recognizing the category, name, etc. of a POI, and recording the category, the name, etc. on a system has been used.

However, such conventional technology has a problem in that a lot of costs, time and efforts are inevitably consumed in collecting, analyzing and processing data because a person must intervenes in an overall processing process, such as that a person visits a location where a corresponding POI is present in order to check POI information in a real space and directly checks and records information or a corresponding location is divided and photographed, and a person subsequently checks a photographed image and checks and records the information.

Furthermore, although POI information on a given real space area has been secured, the POI information may be frequently changed due to new opening, close-down, etc. Accordingly, in order to immediately recognize a change in the POI, POI information needs to be rapidly updated through frequent monitoring for a corresponding space area. However, to obtain/provide the latest information related to a change in the POI is practically almost impossible because a processing method including the intervention of a person consumes costs and many efforts. In particular, if the range of a real space is wide, there is a problem in that a process of checking the latest POI information according to a change in the POI becomes more difficult.

### SUMMARY

Some example embodiments provide an information collection and update method, which is capable of automatically collecting information on multiple points of interest (POIs) present in a real space for a location-based service, such as a map, in a real space environment, such as a city street or an indoor shopping mall, and automatically updating a change when there is the change as a result of a comparison with previously collected information, and/or an information collection and update system performing the information collection and update method.

Some example embodiments provide an information collection and update method, which is capable of reducing or minimizing costs, time and efforts in obtaining and processing information on a change in the POI and maintaining the latest POI information, by reducing or minimizing the intervention of a person in all processes of obtaining and storing the information on a change in the POI because obtaining and processing information on a change in the POI are automated using technologies, such as robotics, computer vision, and deep learning, and/or an information collection and update system performing the information collection and update method.

Furthermore, some example embodiments provide a method of automatically extracting, storing and using direct attribute information on POIs, such as a POI name and category, by analyzing a photographed image of a real space, and/or an information processing method and information processing system capable of extending extractable POI information to a semantic information area which may be checked through image analysis and inference.

According to an example embodiment, an information collection and update method includes storing, in a point of interest (POI) database, a plurality of images photographed at a plurality of locations in a target place in association with a photographing location and photographing timing of each of the images, selecting a target location within the target place, selecting an anterior image and a posterior image based on the photographing timing, among the images stored in the POI database in association with the photographing location corresponding to the target location, and recognizing a POI change in the target location based on the selected anterior image and posterior image.

There is provided a non-transitory computer-readable recording medium storing thereon a program, which when executed by at least one processor, causes a computer including the at least one processor to perform the aforementioned information collection and update method.

According to an example embodiment, a computer device includes at least one processor implemented to execute a computer-readable instruction such that the at least one processor is configured to store, in a point of interest (POI) database, a plurality of images photographed at a plurality of locations in a target place in association with a photographing location and a photographing timing of each of the images, select a target location within the target place, select an anterior image and a posterior image based on the photographing timing, among the images stored in the POI database in association with a specific photographing location corresponding to the target location, and recognize a POI change in the target location based on the selected anterior image and posterior image.

Information on multiple points of interest (POIs) present in a real space for a location-based service, such as a map, is automatically collected in a real space environment, such as a city street or an indoor shopping mall. When there is a change based on a result of a comparison with previously collected information, the change can be automatically updated.

Since obtaining and processing information on a change in the POI are automated using technologies, such as robotics, computer vision, and deep learning, costs, time and efforts in obtaining and processing information on a change in the POI can be minimized and the latest POI information can be always maintained by minimizing the intervention of a person in all processes of obtaining and storing the information on a change in the POI.

Furthermore, direct attribute information on POIs, such as a POI name and category, can be automatically extracted, stored and used by analyzing a photographed image of a real space, and extractable POI information can be extended to a semantic information area, which may be checked through image analysis and inference.

### BRIEF DESCRIPTION OF THE DRAWINGS

FIG. 1 is a diagram illustrating an example of an information collection and update system according to an example embodiment.

FIG. 2 is a flowchart illustrating an example of an information collection and update method according to an example embodiment.

FIG. 3 is a flowchart illustrating an example of a basic information acquisition process in an example embodiment.

FIG. 4 is a diagram illustrating an example of data collected through a mapping robot in an example embodiment.

FIG. 5 is a flowchart illustrating an example of an occasional information acquisition process in an example embodiment.

FIG. 6 is a flowchart illustrating an example of an occasional POI information processing process in an example embodiment.

FIG. 7 is a block diagram illustrating an example of a computer device according to an example embodiment.

### DETAILED DESCRIPTION

Hereinafter, some example embodiments are described in detail with reference to the accompanying drawings.

Some example embodiments of the present invention provide information collection and update methods and/or systems capable of efficiently executing (1) the detection of a POI change, (2) the recognition of attributes of a POI, and (3) the acquisition of semantic information of a POI while reducing or minimizing the intervention of a person.

In a real environment, a POI is frequently changed in various forms, such as that a POI is newly opened or closed down or expanded, or a POI is changed into another shop. To frequently check such a POI change state and maintain the latest POI information has very high importance in location-related services, such as a map.

In this case, POI change detection technology according to some example embodiments can efficiently maintain POI information in the latest state by automatically detecting a change in the POI in an image photographed using a vehicle or a robot and providing an administrator with related information in order to record a change in the POI occurred on a system or automatically recording a change in the POI on a system when the change is very clear.

In an example embodiment, in order to describe the POI change detection technology, a real space is described by taking a large-scale indoor shopping mall as an example. This is for convenience of description, and a real space of the present disclosure is not limited to an indoor shopping mall. Furthermore, in the present example embodiment, an example in which a robot capable of autonomous driving is used as means for obtaining data related to an image for the detection of a POI change is described. The acquisition of information may be performed through various means, such as a vehicle, a person, or CCTV, depending on the type of environment in a real space, and is not limited to a robot presented in the present example embodiment.

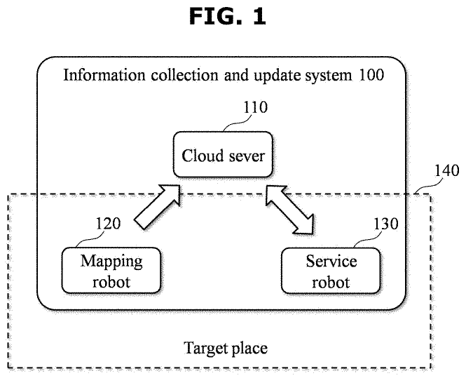

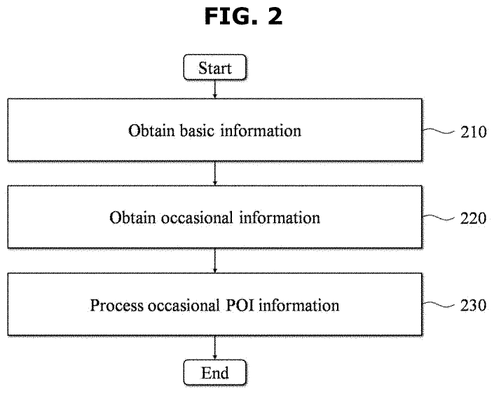

FIG. 1 is a diagram illustrating an example of an information collection and update system according to an example embodiment. FIG. 2 is a flowchart illustrating an example of an information collection and update method according to an example embodiment.

The information collection and update system 100 according to the present example embodiment may be configured to include a cloud sever 110, a mapping robot 120 and a service robot 130. The cloud sever 110 and the mapping robot 120, and the cloud sever 110 and the service robot 130 may be implemented to be capable of performing data communication over a network for the transmission of collected data or the transmission of location information, map information, etc. For example, the service robot 130 may be implemented to include a wireless network interface in order to assign (or provide) the real-time property to data communication with the cloud sever 110.

Furthermore, as illustrated in FIG. 2, the information collection and update method according to the present example embodiment may include a basic information acquisition operation 210, an occasional information acquisition operation 220 and an occasional POI information processing operation 230. The basic information acquisition operation 210 may be performed once at the beginning (two times or more, if desired) for the acquisition of basic information. The occasional information acquisition operation 220 may be repeatedly performed always or whenever desired. Furthermore, the occasional POI information processing operation 230 may be repeated and performed regularly (e.g., on a daily or weekly basis).

In this case, the mapping robot 120 may be implemented to collect data of a target place 140 while traveling the target place 140 and to transmit the data to the cloud sever 110, in the basic information acquisition operation 210. The cloud sever 110 may be implemented to generate basic information on the target place 140 based on the data collected and provided by the mapping robot 120 and to support autonomous driving and service provision of the service robot 130 in the target place 140 using the generated basic information.

Furthermore, the service robot 130 may be implemented to collect occasional information, while autonomously traveling the target place 140 based on the information provided by the cloud sever 110, and to transmit the collected occasional information to the cloud sever 110, in the occasional information acquisition operation 220.

At this time, the cloud sever 110 may update information on the target place 140, such as recognizing and updating a POI change based on a comparison between the basic information and the occasional information, in the occasional POI information processing operation 230.

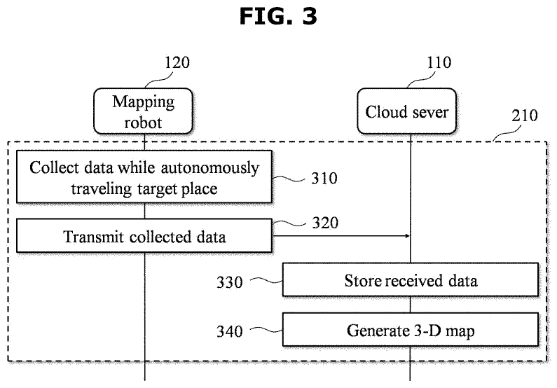

In the basic information acquisition operation 210, the information collection and update system 100 may obtain basic information. The POI change detection technology may detect whether a change is present in a POI by basically comparing (or based on) a current image and an anterior image using various technologies. Accordingly, the previous image, that is, a target of comparison, is desired. Thereafter, for the autonomous driving of a robot (e.g., the service robot 130), an indoor map configuration for the robot is desired. In order to obtain such an anterior image and an indoor map, the basic information acquisition operation 110 may be performed once at the beginning (two or more times, if desired). Detailed operations for the basic information acquisition operation 110 are described with reference to FIG. 3.

FIG. 3 is a flowchart illustrating an example of a basic information acquisition process in an example embodiment. The acquisition of basic information may be performed by the cloud sever 110 and the mapping robot 120 included in the information collection and update system 100. Operations 310 to 340 of FIG. 3 may be included and performed in operation 210 of FIG. 2.

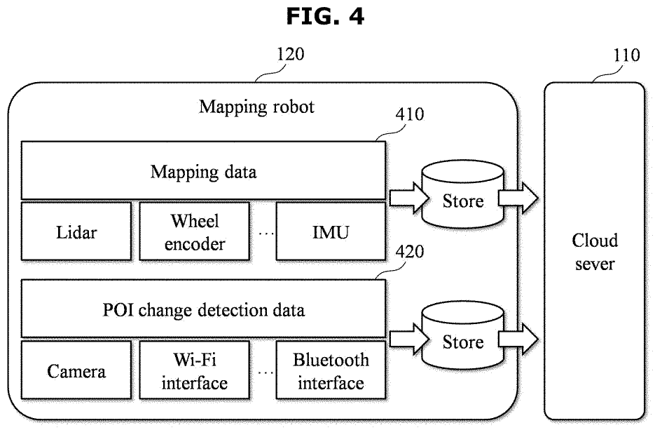

At operation 310, when the target place 140, such as an indoor shopping mall, is selected, the mapping robot 120 may collect data while autonomously traveling the selected target place 140. In this case, the collected data may include data for generating an anterior image to be used for the detection of a POI change and data for an indoor map configuration for the autonomous driving of the service robot 130. To this end, for example, the mapping robot 120 may be implemented to include a Lidar, a wheel encoder, an inertial measurement unit (IMU), a camera, a communication interface, etc. The service robot 130 does not need to have an expensive high-precision sensor mounted thereon like the mapping robot 120 because the service robot performs autonomous driving using an indoor map configured based on data already collected by the mapping robot 120. Accordingly, the service robot 130 may be implemented to have a sensor, relatively cheaper than that of the mapping robot 120. Data collected by the mapping robot 120 is more specifically described with reference to FIG. 4.

At operation 320, the mapping robot 120 may transmit the collected data to the cloud sever 110. According to some example embodiments, the collected data may be transmitted to the cloud sever 110 at the same time when the data is collected, or may be grouped in a zone unit of the target place 140 and transmitted to the cloud sever 110, or may be transmitted to the cloud sever 110 at a time after the collection of data of all the zones of the target place 140 is completed.

At operation 330, the cloud sever 110 may store the data received from the mapping robot 120. For example, in order to collect all data for all the zones of the target place 140 from the mapping robot 120, the cloud sever 110 may store and consistently manage, in a database (POI database), data collected and transmitted by the mapping robot 120.

At operation 340, the cloud sever 110 may generate a three-dimensional (3-D) map using the data stored in the database. The generated 3-D map may be used to help the service robot 130 provide a target service while autonomously traveling the target place 140.

FIG. 4 is a diagram illustrating an example of data collected through the mapping robot in an example embodiment. The mapping robot 120 may collect mapping data 410 for generating a 3-D map of the target place 140 and POI change detection data 420 used to detect a POI change. For example, the mapping data 410 may include measured values (Lidar data, wheel encoder data, IMU data, etc.) measured through a Lidar, a wheel encoder, an IMU, etc. which may be included in the mapping robot 120. The POI change detection data 420 may include data (camera data, such as a photographed image, Wi-Fi signal intensity, a Bluetooth beacon, etc.) obtained through, for example, a camera and communication interfaces (a Wi-Fi interface, a Bluetooth interface, etc.), which may be included in the mapping robot 120. In the example embodiment of FIG. 4, the category of the mapping data 410 and the category of the POI change detection data 420 are classified, for convenience of description, but collected data may be redundantly used for both the generation of a 3-D map and the detection of a POI change. For example, an image photographed through a camera, Wi-Fi signal intensity, etc., may be further used to generate a 3-D map. In order to collect the mapping data 410 and/or the POI change detection data 420, various types of sensors, such as a stereo camera or an infrared sensor, may be used in the mapping robot 120 in addition to the sensors described with reference to FIG. 4.

The mapping robot 120 may photograph a surrounding area at specific intervals (e.g., a 1-second interval while moving 1 m/sec) using the camera mounted on the mapping robot 120, while traveling an indoor space, for example. A 360-angle camera or a wide-angle camera and/or multiple cameras may be used so that the signage of a shop and a shape of the front of a shop chiefly used in the detection of a POI change in a photographed image are efficiently included in the image. An image may be photographed so that the entire area of the target space 140 is included in the image at least partially. In this case, in order to confirm a POI change location, it is desired to know that the photographed image corresponds to an image obtained at what location of the target place 140. Accordingly, the obtained image may be stored in association with an image including location information (photographing location) and/or direction information (photographing direction) of the mapping robot 120 upon photographing. In this case, information on timing at which the image is photographed (photographing timing) may also be stored along with the image. For example, in order to obtain location information, the mapping robot 120 may further collect Bluetooth beacon information or Wi-Fi finger printing data for confirming a Wi-Fi-based location. In order to obtain direction information, values measured by a Lidar or an IMU included in the mapping robot 120 may be used. The mapping robot 120 may transmit the collected data to the cloud sever 110. The cloud sever 110 may generate a 3-D map using the data received from the mapping robot 120, and may process localization, path planning, etc. on the service robot 130 based on the generated 3-D map. Furthermore, the cloud sever 110 may use the data, received from the mapping robot 120, to update information on the target place 140 by comparing the received data with data subsequently collected by the service robot 130 (or based on the received data with data subsequently collected by the service robot 130).

If the target place is indoor, a location included in map data (e.g., an image according to location information, Wi-Fi signal intensity, Bluetooth beacon information, and/or a value measured by a sensor) generated by the mapping robot 120 may be determined relative to a start location. The reason for this is that precise global positioning data cannot be obtained in an indoor space. Furthermore, if the same space is divided several times and scanned, it is difficult to obtain consistent location data because a start location is different every time. Accordingly, for a consistent location data surface and use, a process of converting location data obtained through the mapping robot 120 into a form capable of global positioning is required. To this end, the cloud sever 110 may check an accurate location indicated as actual longitude and latitude of an indoor space, may convert location data, included in map data, into a form according to a geodetic reference system, such as WGS84, ITRF, or PZ, may store the location data, and may use the stored data in a subsequent process.

Referring back to FIGS. 1 and 2, in the occasional information acquisition operation 220, the information collection and update system 100 may obtain occasional information on the target place 140. In the occasional information acquisition operation 220, the 3-D map, the anterior image, the location information, etc. obtained in the basic information acquisition operation 210, that is, a previous operation, may be consistently used.

The cloud sever 110 includes information on the entire space of the target place 140 in the basic information acquisition operation 210 that already has been collected, processed and stored. Accordingly, in the occasional information acquisition operation 220, only some changed information can be obtained and processed, and information on the target place 140, such as a map data, can be efficiently maintained in the latest state. Accordingly, it is not desired to collect the data of the entire space area of the target place 140 every time.

Furthermore, as already described above, in the occasional information acquisition operation 220, the cloud sever 110 includes relatively high-precision map data desired for the autonomous driving of the service robot 130 and generated using various expensive high-precision sensors mounted on the mapping robot 120. Accordingly, an expensive high-precision sensor does not need to be mounted on the service robot 130. For this reason, in the occasional information acquisition operation 220, the service robot 130 may be implemented using an inexpensive robot operating according to its natural service use purposes, such as security, guidance, and cleaning, for the target place 140.

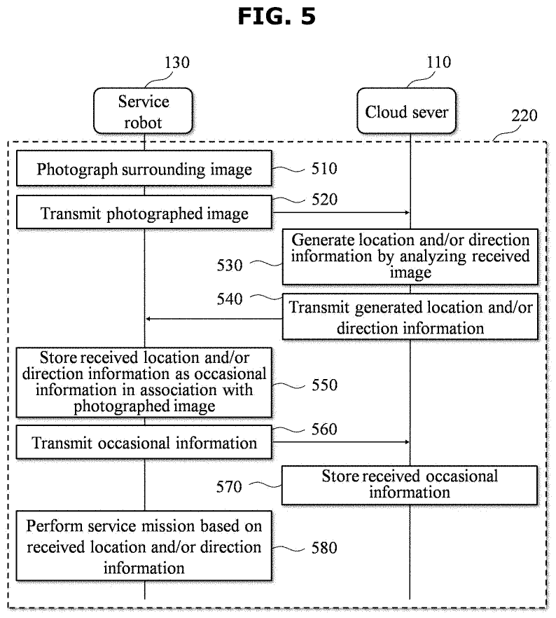

FIG. 5 is a flowchart illustrating an example of an occasional information acquisition process in an example embodiment. The service robot 130 may be positioned within the target place 140 for its natural service purposes, such as security, guidance, and cleaning. Two or more service robots may be disposed in the target place 140 depending on the target place 140 and service purposes, and may be designated to operate in different areas. The acquisition of occasional information may be performed by the cloud sever 110 and the service robot 130 included in the information collection and update system 100. Operations 510 to 580 of FIG. 5 may be included and performed in operation 220 of FIG. 2.

At operation 510, the service robot 130 may photograph a surrounding image in the target place. For example, the service robot 130 may be implemented to include a camera for photographing the surrounding image in the target place. The photographed image may be used for two purposes. First, the photographed image may be used for the purpose of helping the autonomous driving of the service robot 130 by checking a current location (photographing location) and/or direction (photographing direction) of the service robot 130. Second, the photographed image may be used for the purpose of being compared with an anterior image obtained in the basic information acquisition operation 210 as an occasional image for checking a POI change. For the two purposes, the photographed image may require location and/or direction information of the service robot 130 at timing at which the corresponding image was photographed (photographing timing). According to an example embodiment, a photographing cycle of an image for the first purpose and a photographing cycle of an image for the second purpose may be different. The photographing cycle may be dynamically determined based on at least the moving speed of the service robot 130. If the service robot 130 checks a location and/or a direction using Wi-Fi signal intensity or a Bluetooth beacon instead of using an image, the photographing of an image may be used for only the second purpose. If Wi-Fi signal intensity or Bluetooth beacon is used, the service robot 130 may request information on a location and/or a direction by transmitting, to the cloud sever 110, an obtained Wi-Fi signal intensity or Bluetooth beacon in order to check the location and/or the direction. Meanwhile, even in this case, for the second purpose, the acquisition of location and/or direction information related to an image is desired. Thereafter, operation 520 to operation 540 may describe an example of a process of obtaining location and/or direction information related to an image. If the service robot 130 moves, in order to consistently obtain the location of the service robot 130, operation 510 to operation 540 may be performed periodically and/or repeatedly.

At operation 520, the service robot 130 may transmit the photographed image to the cloud server 130. At this time, the service robot 130 may request location and/or direction information corresponding to the transmitted image, while transmitting the image.

At operation 530, the cloud server 130 may generate location and/or direction information of the service robot 130 by analyzing the image received from the service robot 130. In this case, the location and/or direction information may be generated based on pieces of information obtained in the basic information acquisition operation 210. For example, the cloud server 130 may find a matched image by comparing (or based on) an image collected from the mapping robot 120 and an image received from the service robot 130, and may generate location and/or direction information according to a request from the service robot 130 based on location and/or direction information stored in association with the corresponding image. The direction information may be direction information of a camera.

At operation 540, the cloud server 130 may transmit the generated location and/or direction information to the service robot 130.

At operation 550, the service robot 130 may store the received location and/or direction information as occasional information in association with the photographed image. The occasional information may mean information to be used for the second purpose (a purpose for checking a POI change). In this case, the occasional information may further include information on photographing timing of the image.

At operation 560, the service robot 130 may transmit the stored occasional information to the cloud server 130. As the service robot 130 moves, the amount of occasional information may also be increased. The service robot 130 may transmit, to the cloud server 130, occasional information stored permanently, periodically or whenever desired.

At operation 570, the cloud server 130 may store the received occasional information in a database (POI database). The stored occasional information may be used to recognize a POI change through a comparison with pieces of information subsequently obtained in the basic information acquisition operation 210.

At operation 580, the service robot 130 may perform a service mission based on the received location and/or direction information. In the example embodiment of FIG. 5, operation 580 is described as being performed after operation 570. However, operation 580 of performing the service mission may be performed in parallel to operations 550 to 570 using the location and/or direction information of the service robot 130 received at operation 540. According to some example embodiments, localization and path planning for performing the service mission may be performed by the service robot 130, and may be performed through the cloud server 130.

In the above example embodiments, the collection of data of the target place 140 using the mapping robot 120 and the service robot 130 is described, but example embodiments are not limited thereto, and various methods having an equivalent level may be used. For example, in the basic information acquisition operation 210, in order to collect basic information at the beginning once, data of a space may be collected using a sensor mounted on a device, such as a trolley which may be carried by a person, instead of using an expensive the mapping robot 120 capable of autonomous driving. In the occasional information acquisition operation 220, images photographed by smartphones owned by common users who visit the target place 140 may be collected and used, or images of closed circuit television (CCTV) installed in the target place 140 may be collected and used. In other words, the cloud sever 110 may construct a POI database by receiving a basic image and a photographing location and photographing timing of the basic image, obtained through a camera and a sensor included in at least one of the mapping robot 120 that autonomously travels the target place 140 or a trolley that moves the target place 140, over a network. Furthermore, the cloud sever 110 may update the POI database by receiving, over a network, an occasional image of the target place 140 and a photographing location and photographing timing of the occasional image from at least one of the service robot 130 that performs a desired (or alternatively, preset) service mission while autonomously traveling the target place 140, terminals of users including cameras located in the target place 140, or closed circuit television (CCTV) installed the target place 140.

Referring back to FIGS. 1 and 2, the occasional POI information processing operation 230 may be a process for obtaining POI-related information using the basic information obtained by the cloud sever 110 in the basic information acquisition operation 210 and the occasional information obtained in the occasional information acquisition operation 220.

For example, the POI change detection technology may be a process for detecting, by the cloud sever 110, a POI in one basic image and multiple occasional images by analyzing and comparing the corresponding images using technologies, such as computer vision or deep learning, in the occasional POI information processing operation 230, determining whether there is a change in the POI, and updating a POI change into the information collection and update system 100 if there is a change in the POI. For example, the cloud sever 110 may notify an administrator of the information collection and update system 100 of images anterior and posterior to a change in the POI. The information collection and update system 100 determines whether there is a change in the POI in advance, and selectively provides such a change to an administrator. Accordingly, POI information on a wider area can be analyzed, reviewed, and updated in a unit time because the amount of images that needs to be reviewed by the administrator in order to determine a POI change can be significantly reduced. For another example, the cloud sever 110 may directly update the information collection and update system 100 with a name, category, a changed image, etc. of a changed POI.

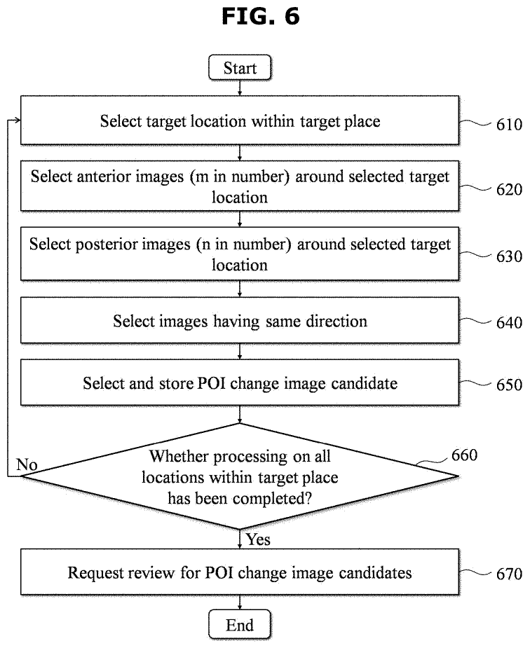

FIG. 6 is a flowchart illustrating an example of an occasional POI information processing process in an example embodiment. As already described above, operations 610 to 670 of FIG. 6 may be performed by the cloud sever 110.

At operation 610, the cloud sever 110 may select a target location within the target place 140. For example, the cloud sever 110 may determine multiple locations within the target place 140 in advance, and may check whether surrounding POIs are changed for each location. For example, the cloud sever 110 may determine multiple locations by dividing the target place 140 in a grid form having desired (or alternatively, preset) intervals, and may select, as a target location, one of the multiple locations determined at operation 610.

At operation 620, the cloud sever 110 may select “m” anterior images (m in number) around the selected target location. For example, the cloud sever 110 may select, as anterior images, images stored in the POI database in association with a photographing location located within a desired (or alternatively, preset) distance from the target location.

At operation 630, the cloud sever 110 may select “n” posterior images (n in number) around the selected target location. For example, the cloud sever 110 may select, as posterior images, images stored in the POI database in association with a photographing location located within a desired (or alternatively, preset) area from the target location. In other words, at operations 620 and 630, the cloud server 110 may select at least an anterior image and a posterior image based on the photographing timing, among the images stored in the POI database in association with a specific photographing location corresponding to the target location.

In this case, to separately select the anterior images and the posterior images may be based on photographing timing of the images. In order to detect a change in the POI, an anterior image and a posterior image, that is, a subject of comparison, are basically desired. An anterior image may be first selected among images collected in the basic information acquisition operation 210. A posterior image may be selected among images collected in the occasional information acquisition operation 220. However, if images are collected at pieces of different timing in the occasional information acquisition operation 220, a posterior image may be selected among occasional images photographed at the most recent timing, and an anterior image may be selected among posterior images previously used for a comparison or occasional images photographed at previous timing (e.g., before a day or before a week).

At operation 640, the cloud sever 110 may select images having the same direction. To select images having the same direction is for comparing an anterior image and a posterior image photographed at similar locations in similar directions. If the two images of the anterior image and the posterior image photographed at the similar locations have directional similarity of a degree (e.g., a threshold degree) that identical portions are expected to have been photographed at a desired (or alternatively, preset) ratio, the two images may be selected as a pair of the same direction images. For another example, if photographing directions of two image are formed within a threshold (or alternatively, desired or preset) angle difference, the corresponding two image may be selected as a pair of images having the same direction.

At operation 650, the cloud sever 110 may select and store a POI change image candidate. The cloud sever 110 may perform descriptor-based matching on each of the pair of same direction images, may determine that there is no POI change if the matching for the pair of same direction images is successful, and may determine that a POI change is present if the matching for the pair of same direction images fails. In other words, the cloud sever 110 may extract natural feature descriptors from an anterior image and an posterior image, included as the pair of same direction images, respectively, using an algorithm, such as scale invariant feature transform (SIFT), or speeded up robust features (SURF), may compare the extracted descriptors, and may store an anterior image and a posterior image that are not matched as a result of the comparison as POI change image candidates in association with information on the target location. According to some example embodiments, multiple anterior images and multiple posterior images may be compared.

According to an example embodiment, the selected POI change image candidates may be further selected (e.g., filtered) using a method, such as recognizing a signage or the front of a shop using a deep learning scheme.

At operation 660, the cloud sever 110 may determine whether processing on all locations within the target place 140 has been completed. For example, if the processing on all the locations has not been completed, the cloud sever 110 may repeatedly perform operations 610 to 660 in order to select a POI change image candidate by selecting a next location within the target place 140 as the target location. If the processing on all the locations has been completed, the cloud sever 110 may perform operation 670.

At operation 670, the cloud sever 110 may request a review for the POI change image candidates. Such a request for the review may be transmitted to an administrator of the information collection and update system 100. In other words, an anterior image and a posterior image corresponding to a POI change may be transmitted to the administrator along with location information (target location). Such information may be displayed in a map on software through which the administrator may input change information according to the POI change, and may help the administrator review and check the information on the POI change once more and then input information. In other words, the cloud sever 110 may generate POI change information, including at least an anterior image and an posterior image related to the recognition of a POI change, and may provide the POI change information to the administrator so that the administrator may input (e.g., update) information on a corresponding POI based on the generated POI change information.

Meanwhile, a POI having a specific category may be identified based on the descriptor of an image. For example, in the case of well-known franchise stores, a specific descriptor pattern may be included in an image. Accordingly, the cloud sever 110 may learn images, including corresponding POIs, over a deep neural network with respect to a POI having a specific category, such as franchise stores, and may determine whether a franchise store is present in a specific image. In this case, if it is determined that a specific franchise store is present in an image determined to have a POI change in the occasional POI information processing operation 230, the cloud sever 110 may directly recognize the name, category, etc. of the corresponding franchise store, and may update the information collection and update system 100 with the recognized name, category, etc. In an example embodiment, the cloud sever 110 may train a deep learning model to extract the attributes of a franchise store, included in an input image, based on the descriptor of the input image, using images including franchise stores as learning data, and may update information on a corresponding POI using the attributes of a franchise store extracted from a posterior image related to the recognized POI change using the trained deep learning model.

For example, the cloud sever 110 may directly determine whether a review will be performed by an administrator based on the reliability of franchise recognition results, and may determine whether to directly collect information on a POI change and update the collection and update system 100 with the collected information or whether to notify the administrator of the POI change based on the determined results.

Furthermore, as described above, the cloud sever 110 may directly extract attributes, such as the name, category, etc. of a changed POI within an image through image analysis for a POI change image candidate, and may update the information collection and update system 100 with the extracted attributes. For example, an optical character reader (OCR) or image matching and image/text mapping technologies may help the cloud sever 110 directly recognize the attributes of a POI within an image.

The OCR is technology for extracting text information by detecting a character area in an image and recognizing a character in the corresponding area. The same technology may be used for various character sets using a deep learning scheme in order to detect and recognize the character area. For example, the cloud sever 110 may recognize the attributes of a corresponding POI (POI name, POI category, etc.) by extracting information, such as the name, telephone, etc. of a shop, from the signage of the shop through the OCR.

Furthermore, in implementing the POI change detection technology, the POI database in which various images of POIs and POI information of the image are written may be used. Such data may be used as learning data for deep learning, and may be used as basic data for image matching. A deep learning model may be trained to output POI information of an input image, for example, a POI name and category, based on data of the POI database. Image data of the POI database may be used as basic data for direct image matching. In other words, the POI database may be searched for an image most similar to an input image. Text information, such as a POI name and category stored in the POI database may be searched for in association with the retrieved image, and may be used as the attributes of the POI included in the input image. In an example embodiment, the cloud sever 110 may construct the POI database based on information obtained through the POI change detection technology, may train the deep learning model using data of the constructed POI database as learning data, and may use the deep learning model to recognize the attributes of a POI. As described above, the cloud sever 110 may train the deep learning model to extract the attributes of a POI, which is included in an input image, using images stored in the POI database and a set of attributes of a respective POI included in each of the images as learning data, and may update information on the corresponding POI with the attributes of a POI extracted from a posterior image related to a POI change recognized using the trained deep learning model.

For example, a POI included in an image may be directly extracted by recognizing text information through the OCR. In contrast, the category, etc. of a shop may not be directly recognized only based on recognized text information. Accordingly, datafication is desired by predicting or recognizing whether a corresponding shop is a restaurant or a café or whether a restaurant is a fast-food restaurant or a Japanese restaurant or a Korean restaurant. In some example embodiments, the cloud sever 110 may extend the POI database by predicting and recognizing a POI category using collected image data and the POI database and making data additional information, such as an operating hour of a shop recognized in an image.

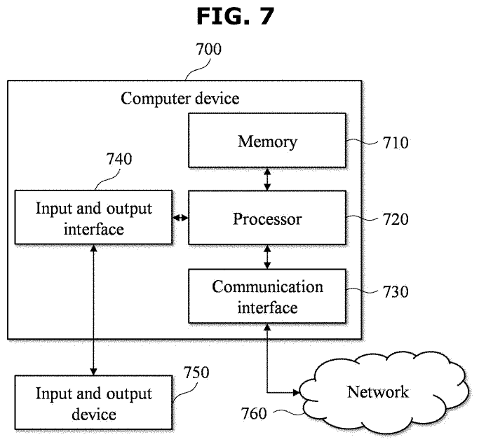

FIG. 7 is a block diagram illustrating an example of a computer device according to an example embodiment. The aforementioned cloud sever 110 may be implemented by one computer device 700 or a plurality of computer devices illustrated in FIG. 7. For example, a computer program according to an example embodiment may be installed and driven in the computer device 700. The computer device 700 may perform the information collection and update method according to some example embodiments under the control of the driven computer program.

As illustrated in FIG. 7, the computer device 700 may include a memory 710, a processor 720, a communication interface 730, and an input and output interface 740. The memory 710 is a computer-readable recording medium, and may include permanent mass storage devices, such as a random access memory (RAM), a read only memory (ROM) and a disk drive. In this case, the permanent mass storage device, such as a ROM and a disk drive, may be included in the computer device 700 as a permanent storage device separated from the memory 710. Furthermore, an operating system and at least one program code may be stored in the memory 710. Such software elements may be loaded from a computer-readable recording medium, separated from the memory 710, to the memory 710. Such a separate computer-readable recording medium may include computer-readable recording media, such as a floppy drive, a disk, a tape, a DVD/CD-ROM drive, and a memory card. In another example embodiment, software elements may be loaded onto the memory 710 through the communication interface 730 not a computer-readable recording medium. For example, the software elements may be loaded onto the memory 710 of the computer device 700 based on a computer program installed by files received over a network 760.

The processor 720 may be configured to process instructions of a computer program by performing basic arithmetic, logic and input and output operations. The instructions may be provided to the processor 720 by the memory 710 or the communication interface 730. For example, the processor 720 may be configured to execute received instructions based on a program code stored in a recording device, such as the memory 710.

The communication interface 730 may provide a function for enabling the computer device 700 to communicate with other devices (e.g., the aforementioned storage devices) over the network 760. For example, a request, an instruction, data or a file generated by the processor 720 of the computer device 700 based on a program code stored in a recording device, such as the memory 710, may be provided to other devices over the network 760 under the control of the communication interface 730. Inversely, a signal, an instruction, data or a file from another device may be received by the computer device 700 through the communication interface 730 of the computer device 700 over the network 760. The signal, instruction or data received through the communication interface 730 may be transmitted to the processor 720 or the memory 710. The file received through the communication interface 730 may be stored in a storage device (i.e., the aforementioned permanent storage device) which may be further included in the computer device 700.

The input and output interface 740 may be means for an interface with an input and output device 750. For example, the input device may include a device, such as a microphone, a keyboard, or a mouse. The output device may include a device, such as a display or a speaker. For another example, the input and output interface 740 may be means for an interface with a device in which functions for input and output have been integrated into one, such as a touch screen. The input and output device 750, together with the computer device 700, may be configured as a single device.

Furthermore, in some example embodiments, the computer device 700 may include components greater or smaller than the components of FIG. 7. However, it is not desired to clearly illustrate most of conventional components. For example, the computer device 700 may be implemented to include at least some of the input and output devices 750 or may further include other components, such as a transceiver and a database,

As described above, according to the example embodiments, information on multiple points of interest (POIs) present in a real space for a location-based service, such as a map, is automatically collected in a real space environment, such as a city street or an indoor shopping mall. When there is a change as a result of a comparison with previously collected information, the change can be automatically updated. Because obtaining and processing information on a change in the POI are automated using technologies, such as robotics, computer vision, and deep learning, costs, time and efforts in obtaining and processing information on a change in the POI can be reduced or minimized and the latest POI information can be always maintained by reducing or minimizing the intervention of a person in all processes of obtaining and storing the information on a change in the POI. Furthermore, direct attribute information on POIs, such as a POI name and category, can be automatically extracted, stored and used by analyzing a photographed image of a real space, and extractable POI information can be extended to a semantic information area which may be checked through image analysis and inference.

The aforementioned system or device may be implemented by a hardware component or a combination of a hardware component and a software component. For example, the device and components described in the example embodiments may be implemented using one or more general-purpose computers or special-purpose computers, like a processor, a controller, an arithmetic logic unit (ALU), a digital signal processor, a microcomputer, a field programmable gate array (FPGA), a programmable logic unit (PLU), a microprocessor or any other device capable of executing or responding to an instruction. The processor may perform an operating system (OS) and one or more software applications executed on the OS. Furthermore, the processor may access, store, manipulate, process and generate data in response to the execution of software. For convenience of understanding, one processing device has been illustrated as being used, but a person having ordinary skill in the art may understand that the processor may include a plurality of processing elements and/or a plurality of types of processing elements. For example, the processor may include a plurality of processors or a single processor and a single controller. Furthermore, a different processing configuration, such as a parallel processor, is also possible

Software may include a computer program, a code, an instruction or a combination of one or more of them and may configure a processor so that it operates as desired or may instruct the processor independently or collectively. The software and/or data may be embodied in a machine, component, physical device, virtual equipment or computer storage medium or device of any type in order to be interpreted by the processor or to provide an instruction or data to the processor. The software may be distributed to computer systems connected over a network and may be stored or executed in a distributed manner. The software and the data may be stored in one or more computer-readable recording media

The methods according to the example embodiments may be implemented in a non-transitory computer-readable recording medium storing a computer readable instructions thereon, which when executed by at least one processor, cause a computer including the at least one processor to perform the methods. The computer-readable instructions may include a program instruction, a data file, and a data structure solely or in combination. The non-transitory computer-readable recording medium may permanently store a program executable by a computer or may temporarily store the program for execution or download. Furthermore, the non-transitory computer-readable recording medium may be various recording means or storage means of a form in which one or a plurality of pieces of hardware has been combined. The non-transitory computer-readable recording medium is not limited to a medium directly connected to a computer system, but may be one distributed over a network. An example of the non-transitory computer-readable recording medium may be one configured to store program instructions, including magnetic media such as a hard disk, a floppy disk and a magnetic tape, optical media such as CD-ROM and a DVD, magneto-optical media such as a floptical disk, ROM, RAM, and flash memory. Furthermore, other examples of the non-transitory computer-readable recording medium may include an app store in which apps are distributed, a site in which other various pieces of software are supplied or distributed, and recording media and/or storage media managed in a server. Examples of the program instruction may include machine-language code, such as a code written by a compiler, and a high-level language code executable by a computer using an interpreter,

As described above, although some example embodiments have been described in connection with the drawings, those skilled in the art may modify and change the some example embodiments in various ways from the description. For example, proper results may be achieved although the above descriptions are performed in order different from that of the described method and/or the aforementioned elements, such as a system, a configuration, a device, and a circuit, are coupled or combined in a form different from that of the described method or replaced or substituted with other elements or equivalents.

Accordingly, other implementations, other example embodiments, and equivalents of the claims fall within the scope of the claims.

What is claimed is:

1. An information collection and update method comprising:
storing, in a point of interest (POI) database, a plurality of images photographed at a plurality of locations in a target place in association with a photographing location and a photographing timing of each of the images;
selecting a target location within the target place;
selecting an anterior image and a posterior image based on the photographing timing, among the images stored in the POI database in association with the photographing location corresponding to the target location; and
recognizing a POI change in the target location based on the selected anterior image and posterior image.

2. The information collection and update method of claim 1, wherein the storing comprises constructing the POI database by receiving a basic image, obtained through a camera and a sensor included in at least one of a mapping robot autonomously traveling the target place or a trolley moving the target place, and the photographing location of the basic image, and the photographing timing of the basic image, over a network.

3. The information collection and update method of claim 1, wherein the storing comprises updating the POI database by receiving a photographed occasional image of the target place, the photographing location of the photographed occasional image and the photographing timing of the photographed occasional image from at least one of a service robot that performs a service mission while autonomously traveling the target place, a terminal including cameras and located in the target place, or closed circuit television (CCTV) positioned at the target place, over a network.

4. The information collection and update method of claim 1, wherein:
the storing comprises storing each of the images in the POI database further in association with a photographing direction of each of the image, and
the selecting an anterior image and a posterior image comprises selecting a pair of images, from among the images, having an identical direction based on the photographing direction as the anterior image and the posterior image.

5. The information collection and update method of claim 4, wherein the selecting an anterior image and a posterior image comprises selecting a pair of images, from among the images, having a directional similarity of a degree as the anterior image and the posterior image in response to identical portions between the pair of images being expected to be photographed at a ratio or more based on the photographing direction, or in response to the pair of images having the photographing direction within a threshold angle difference.

6. The information collection and update method of claim 1, wherein the recognizing comprises recognizing the POI change based on a descriptor of the anterior image and a descriptor of the posterior image.

7. The information collection and update method of claim 1, wherein the recognizing comprises recognizing the POI change based on pieces of text extracted from the anterior image and the posterior image through an optical character reader (OCR).

8. The information collection and update method of claim 1, further comprising:
generating POI change information comprising at least the anterior image and the posterior image related to the recognizing the POI change, and
providing the POI change information to an administrator so that the administrator updates information on a corresponding POI based on the generated POI change information.

9. The information collection and update method of claim 1, further comprising:
training a deep learning model to extract attributes of a franchise store included in an input image based on a descriptor of the input image, using a set of images comprising the franchise store as learning data; and
updating information on a corresponding POI based on the attributes of the franchise store extracted from the posterior image related to the recognizing the POI change using the trained deep learning model.

10. The information collection and update method of claim 1, further comprising:
training a deep learning model to extract attributes of a POI, included in an input image, using the images stored in the POI database and a set of attributes of a respective POI included in each of the stored images as learning data; and
updating information on the POI based on the attributes of the POI extracted from the posterior image related to the recognizing the POI change using the trained deep learning model.

11. A non-transitory computer-readable recording medium storing thereon a program, which when executed by at least one processor, causes a computer including the at least one processor to perform the method according to claim 1.

12. A computer device comprising:
at least one processor implemented to execute a computer-readable instruction such that the at least one processor is configured to,
store, in a point of interest (POI) database, a plurality of images photographed at a plurality of locations in a target place in association with a photographing location and a photographing timing of each of the images,
select a target location within the target place,
select an anterior image and a posterior image based on the photographing timing, among the images stored in the POI database in association with a specific photographing location corresponding to the target location, and
recognize a POI change in the target location based on the selected anterior image and posterior image.

13. The computer device of claim 12, wherein the at least one processor is configured to construct the POI database by receiving a basic image, obtained through a camera and a sensor included in at least one of a mapping robot autonomously traveling the target place or a trolley moving the target place, and the photographing location of the basic image and the photographing timing of the basic image over a network.

14. The computer device of claim 12, wherein the at least one processor is configured to update the POI database by receiving the photographed occasional image of the target place and the photographing location of the photographed occasional image and a photographing timing of the photographed occasional image from at least one of a service robot performing a service mission while autonomously traveling the target place, a terminal including cameras and located in the target place, or closed circuit television (CCTV) positioned at the target place over a network.

15. The computer device of claim 12, wherein the at least one processor is configured to,
store each of the images in the POI database further in association with a photographing direction of each of the image, and
select a pair of images, from among the images, having an identical direction based on the photographing direction as the anterior image and the posterior image.

16. The computer device of claim 12, wherein the at least one processor is configured to recognize the POI change based on a descriptor of the anterior image and a descriptor of the posterior image.

17. The computer device of claim 12, wherein the at least one processor is configured to recognize the POI change based on pieces of text extracted from the anterior image and the posterior image through an optical character reader (OCR).

18. The computer device of claim 12, wherein the at least one processor is configured to,
generate POI change information comprising at least the anterior image and the posterior image related to the recognition of the POI change, and
provide the POI change information to an administrator so that the administrator updates information on a corresponding POI based on the generated POI change information.

19. The computer device of claim 12, wherein the at least one processor is configured to,
train a deep learning model to extract attributes of a franchise store included in an input image based on a descriptor of the input image, using a set of images comprising the franchise store as learning data, and
update information on a corresponding POI based on the attributes of the franchise store extracted from the posterior image related to the recognized POI change using the trained deep learning model.

20. The computer device of claim 12, wherein the at least one processor is configured to,
train a deep learning model to extract attributes of a POI, included in an input image, using the images stored in the POI database and a set of attributes of a respective POI included in each of the stored images as learning data, and
update information on a POI based on the attributes of the POI extracted from the posterior image related to the recognized POI change using the trained deep learning model.
